(19) United States
(12) Patent Application Publication
(10) Pub. No.: US 2016/0229127 A1
(43) Pub. Date: Aug. 11, 2016

(54) MANUFACTURING METHOD

(71) Applicant: 3T RPD LIMITED, Berkshire (GB)

(72) Inventors: Ian Halliday, Berkshire (GB); Jon Vickers, Berkshire (GB)

(73) Assignee: 3T RPD LIMITED, Berkshire (GB)

(21) Appl. No.: 15/022,088

(22) PCT Filed: Sep. 18, 2014
(86) PCT No.: PCT/GB2014/052847

§ 371 Date: Mar. 15, 2016

(30) Foreign Application Priority Data
Sep. 19, 2013 (GB) 1316670.7

(51) Int. Cl. B29C 67/00; B22F 3/105

(52) U.S. Cl. CPC B29C 67/0092; B29C 67/0077; B22F 3/1055; B22F 2003/1058; B33Y 10/00

(57) ABSTRACT

An additive manufacturing method comprises the steps of using an additive manufacturing technique to manufacture a product (10), at least part of which is supported by a support (12) formed integrally with the product (10) as part of the additive manufacturing technique, wherein the support (12) comprises a plurality of support beams (16) which, when finished, extend continuously to substantially interconnect the part with a support table (18), the beams (16) intersecting one another to form a lattice, and separating the support from the product, wherein the lattice is of irregular form.

This invention relates to a method of manufacture, and in particular to an additive manufacturing method for use in the manufacture of a product, component or part.

Additive manufacturing methods are in increasingly widespread use in the manufacture of products. A number of such methods are known. One well known method is a powder bed method in which a uniform, thin layer of a powdered material from which a product is to be manufactured is laid down upon a support. A laser or other heating device is then used to heat parts of the layer to cause the material within the heated parts to fuse together. The parts which are heated in this way are the parts of the layer which will go on to form part of the product. After heating of all of the required parts of the layer has been completed, a fresh uniform layer of powdered material is applied over both the treated and untreated parts of the preceding layer, and the heating process repeated to heat just those parts of the layer which will go on to form part of the finished product. The heating process not only causes fusing of the particles of the powder within the layer to one another, but also causes fusing between the particles of the layer and the immediately preceding layer.

It will be appreciated that by repeating the process of applying a fresh layer of powder, and heating selected parts of the layer a number of times, the final product can be built up in a series of layers. The product will be encased within, and may also contain, the powder from each part of each layer which has not been heated. After all of the layers have been built up, the product can be removed from the untreated, unheated powder. Various cleaning and finishing operations may then be undertaken. Depending upon the material of the product, these finishing operations may include a further heating or fusing operation.

Products of a range of materials may be manufactured using a technique of the type outlined hereinbefore. By way of example, a range of plastics materials may be used. Furthermore, the manufacture of products of a range of metallic materials is becoming increasingly common.

Manufacture of products using this method can be advantageous for a number of reasons. Compared to moulding or casting of products, the range of shapes of products which can be manufactured relatively easily is enhanced. Furthermore, as there is no need to manufacture a mould, the cost of production, especially where only small quantities of the product are required, can be significantly reduced. Compared to machining processes, considerably less waste is produced thus where a product is to be manufactured from an expensive material, significant materials cost savings can be made. Again, the range of shapes of products which can be manufactured relatively easily may be increased.

Whilst the powder bed technique outlined hereinbefore is one additive manufacturing technique, a number of others are known. By way of example, techniques are known in which layers of a product are ‘printed’ or deposited upon one another. By way of example, layers of suitable plastics materials in a viscous, molten form may be deposited upon one another and allowed to cool and solidify to form the final product, or a stream of a powdered material may be directed to form layers of the required shape, a heating device heating the stream of powder as it is deposited to cause fusing of the powder in the desired positions.

Whilst the additive manufacturing techniques outlined hereinbefore can be used to successfully produce products of a range of shapes, difficulties can be faced in manufacturing certain shapes of product. By way of example, if the shape of a product is such that it includes an overhang, for example it may include a central shaft from which an outwardly projecting, overhanging part extends part way along the length of the shaft, whilst manufacture of the shaft portion using an additive manufacturing process may be reasonably straightforward, manufacture of the outwardly projecting, overhanging part may require the presence of some form of support. In the absence of a support, the overhanging part may deflect and so be of the incorrect shape or in the incorrect position, or the underside of the part may be of poor surface finish. Where a powder bed technique is used, then the untreated powder of the layers beneath the parts which will form the overhanging part may serve to provide a degree of support. However, depending upon the materials used, the degree of support provided by the powder of these layers may not be sufficient. By way of example, where a metallic component is to be formed, then initially the underlying layers may function as a support carrying the layers of material which will go on to form the outwardly projecting, overhanging part. However, as the manufacturing process continues, the heating and subsequent cooling of parts of the product induces stresses within the product which may cause deflection of parts thereof. The deflection could be a downwards deflection, and the untreated powder beneath the outwardly projecting part may be incapable of bearing loads arising from such deflection. Furthermore, depending upon the shape of the product being formed, the deflection could be in the upward direction, and the untreated powder layers are unable to restrain the outwardly projecting part against any such upwards deflection.

If the manufacturing technique used is one in which layers of the product are deposited, then the support issues set out above are exaggerated as there are no underlying layers of untreated material.

It is known to provide support for parts of a product requiring support by, during the manufacturing process, constructing a support as well as the product, and as part of the finishing operation, to separate the product from the support. Such supports are typically columnar in shape, and have a profile substantially the same as or similar to the profile of the part requiring support. It is known to design the part of the support which joins onto the product to take the form of a series of castellations to assist in the subsequent separation of the product from the support.

It has been found that such supports can result in difficulties being faced during the finishing process. Where the technique used is a powder bed technique, the supports tend to trap untreated powder, making it difficult to remove all of the untreated powder from the product. Separation of the product from the support without causing damage to the product can also be difficult as the area of connection between the castellated part of the support and the product is relatively large.

The shape of the support does not typically take into account the size of the loadings to which the support may be exposed in use, and so there is a significant risk that the support is either over engineered, resulting in a waste of material, or is not sufficiently strong to bear the applied loads, in use. Furthermore, no account is taken of stresses, including thermally induced stresses, generated within the support, and so the support may be incapable of properly accommodating the results of such stresses.

Another function of the support may be to conduct heat away from the heated parts of the layer, and the design of the support typically does not take this function into account. The heated parts may thus be subject to inappropriately non-uniform cooling.

WO2013/076549, WO2012/131481 and US2013/07193 describe the provision of supports for a part, some of the supports being interconnected. In some of the arrangements, the supports are interconnected to form large scale branching or tree-like structures. US2009/039570, WO2012/036103 and US2002/171177 describe the provision of supports in the form of beams interconnected with one another to form regular lattices. However, as mentioned above, these regular lattices do not take into account the nature or magnitude of the loadings to which parts of the support will be exposed, in use, and so the disadvantages mentioned above are applicable to these arrangements.

It is an object of the invention to provide a manufacturing method in which at least some of the disadvantages set out hereinbefore are overcome or are of reduced impact.

According to the present invention there is provided an additive manufacturing method comprising the steps of:

using an additive manufacturing technique to manufacture a product, at least part of which is supported by a support formed integrally with the product as part of the additive manufacturing technique, wherein the support comprises a plurality of support beams which, when finished, extend continuously to substantially interconnect the part with a support table, the beams intersecting one another to form a lattice; and

separating the support from the product;

wherein the lattice is of irregular form.

By way of example, the irregular lattice may be of random or pseudo random structure.

It will be appreciated that by using a support in the form of a lattice, the risk of untreated material being trapped by the support, where the technique is a powder bed technique, is reduced, as the openings present within the lattice will assist in permitting removal of the untreated powder.

The interconnections of the beams may be such that the lattice has a cellular or foam-like form or structure. Conveniently, where the lattice is of foam-like form, it is of open cell foam-like form.

The irregularity of the lattice may give rise to the density of the lattice being varied such that the level of support provided to the product can be tailored to the requirements of the product. In some parts of the support, the density may be as high as 100%. By way of example, the density of the lattice may be varied by varying the thickness of the beams or the spacing of the beams. The beams may all be of the same thickness, or some may be of a different thickness to others. Furthermore, each beam may be of uniform thickness through its length, or its thickness may vary along its length.

The beams are conveniently of small dimensions, with the result that the contact area between each beam and the product is very small. Each beam may be of cross sectional area of 1 mm² or less, although the invention is not restricted in this regard and the cross-section area could be, say, 10-20 times this size. The contact area between each beam and the product is conveniently less than 1 mm², but could be considerably smaller than this. Where the manufacturing technique uses a laser to heat the material of the support to cause sintering thereof, then the minimum size will be dictated to some extent by the laser spot size. It is thought that in such arrangements a contact area of as small as around 0.1 mm² may be used. It is thought that such an arrangement will allow separation of the support from the product in a relatively simple manner, with minimal damage to the surface of the product. In accordance with an embodiment of the invention, therefore, the support has a large number of small contact points with the product, rather than a relatively small number of relatively large contact points as is conventional.

The average beam length between adjacent intersections may be in the region of 1 mm or less, although the invention is not restricted in this regard and also covers arrangements with larger beam lengths between adjacent intersections.

Depending upon the support requirements of the product, the contact area may be varied. By way of example, if it is thought that the support will be in tension, the contact area may be increased.

The supporting function provided by the support may take the form of bearing the weight of parts of the product or may take the form of retaining parts of the product against movement, for example arising from stresses generated in the product during the manufacturing process. The support, or parts thereof, may thus be under tension or under compression. There may be circumstances in which the function provided by parts of the support changes as the manufacturing process progresses. By way of example, some parts of the support may initially serve a load or weight bearing function and subsequently perform a retaining function, or vice versa, as the manufacturing process progresses. Furthermore, in some parts of the manufacturing process it may be desired for the support, or parts thereof, to be designed to flex to accommodate stresses within the product rather than to restrain the product, or parts thereof, against movement. For example, there may be periods of the manufacturing process in which some flexing of the product can be tolerated or permitted, and the support, or parts thereof, may be designed to resiliently flex to accommodate such flexing of the product at these points in the process.

The invention also relates to a product and support manufactured using the method outlined hereinbefore.

The invention will further be described, by way of example, with reference to the accompanying drawings, in which:

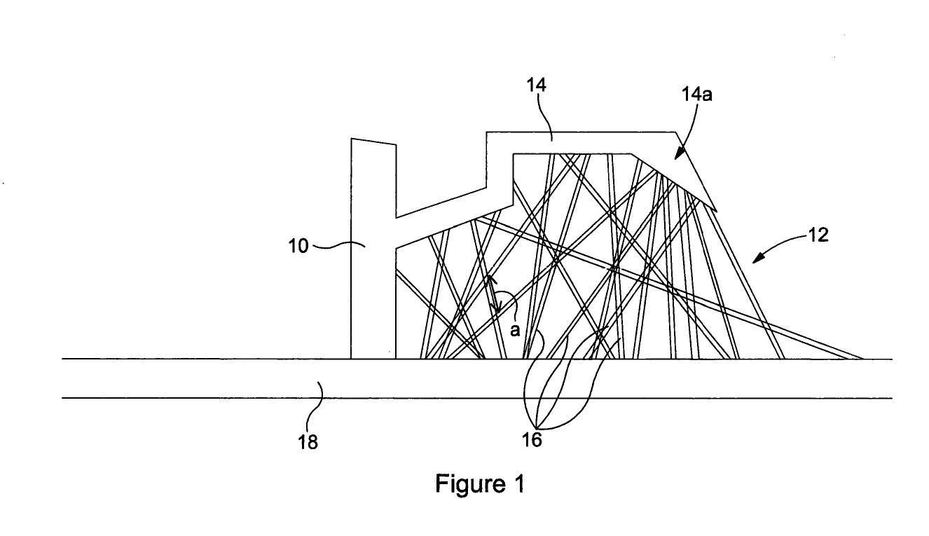

FIG. 1 is a simplified diagrammatic representation, to an enlarged scale, of a product and support, the support still being attached to the product, at an intermediate stage in the manufacturing process;

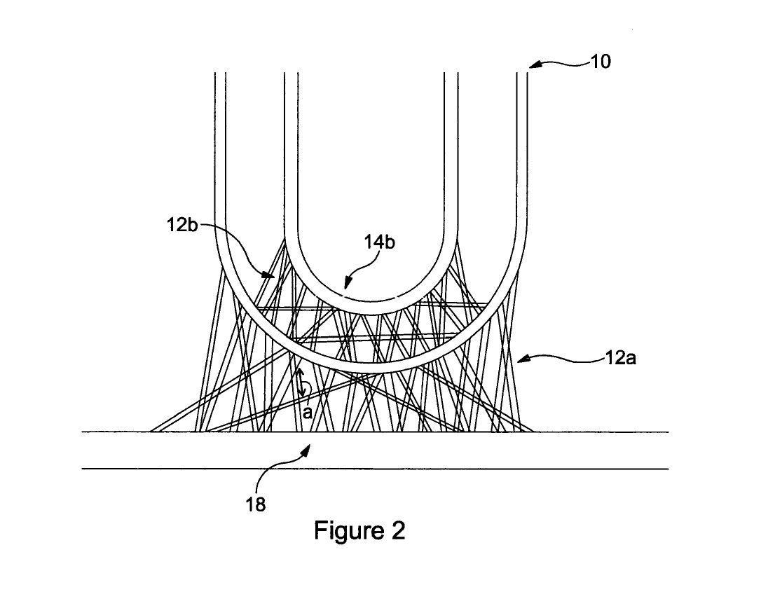

FIG. 2 is a similar diagrammatic representation illustrating an alternative form of support;

FIGS. 3a and 3b are views illustrating other forms of lattice; and

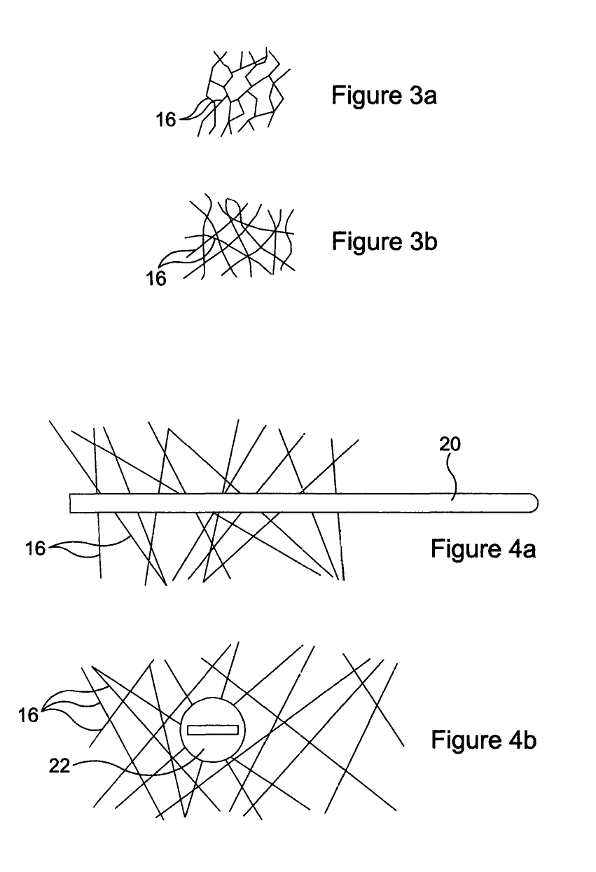

FIGS. 4a and 4b illustrate modifications to the arrangements shown in FIGS. 1 to 3.

Referring to FIG. 1, a product 10 is illustrated which has been manufactured using a powder bed type additive manufacturing process. Such processes are well known and so will not be described herein in further detail. By way of example, the product and support may be manufactured by the use of a powder bed technique, and the product and support may, if desired, be of metallic form. The product 10 is integrally formed with a support 12 which provided support, during the manufacturing process, to an overhanging part 14 of the product 10 which required support.

The support 12 takes the form of a plurality of beams 16, each of which extends continuously from a table 18 upon which the product 10 is formed during the manufacturing process to the part 14. The beams 16 interconnect with one another to form an irregular open lattice. It will be appreciated that in such an arrangement, the nature of the open lattice ensures that little, if any, untreated powder is trapped, all or substantially all of the untreated powder being able to be removed, for example by the use of a suitable blasting or cleaning technique. Clearly, by allowing substantially all of the untreated powder to be removed, waste can be reduced. Furthermore, as any unremoved powder adhering to the product could become permanently bonded thereto as part of a subsequent finishing process, ensuring that all untreated powder is removed reduces the risk of the formation of imperfections in the finished product, or simplifies finishing of the product by reducing the amount of finishing and cleaning work required.

In the arrangement illustrated diagrammatically in FIG. 1, the beams 16 are of substantially the same thickness as one another and are of substantially uniform thickness along their entire lengths, for example in the region of 1 mm² or less cross sectional area, but this need not be the case. For example, significantly larger cross-sectional area beams may be employed. The dimensions of each beam may be chosen, along with the position of each beam, to achieve the desired level of support for the overhanging part 14. In the arrangement shown, the tip 14a of the overhanging part 14 is thought to require more support than the remainder of the part 14, and so there is an increased concentration of beams 16 connected to the tip 14a compared to the other regions of the part 14. Furthermore, although each beam 16 is illustrated as extending in a straight line between the table 18 and the part 14, this need not be the case. Each beam, or at least some of the beams, could be of curved form or may be formed of a series of interconnected straight sections, as illustrated in FIGS. 3a and 3b. Such arrangements could take on an irregular honeycomb structure.

In FIG. 1, the number of beams 16 shown is relatively small for clarity. In practise, the number of beams would typically be considerably higher than is shown. The actual spacing and position of the beams 16 is chosen depending upon the level of support required to bear the loads which are expected to be applied during the manufacturing process. The average beams spacing may be uniform through the support 12, or may vary, depending upon the support requirements as mentioned above. By way of example, the average beam length a between adjacent interconnections may be as low as 1 mm or less, but could be higher such as up to around 10-20 mm.

The contact area between each individual beam 16 and the part 14 is small, for example it could be as small as in the region of 0.1 mm², but it will be appreciated that the invention is not restricted in this regard and that smaller or larger contact areas may be used without departing from the scope of the invention. As the number of beams 16 supporting the part 14 is large, it will be appreciated that whilst each individual contact area is of small dimensions, the overall contact area is sufficiently large as to provide, in combination with the strength of the beams 16, the required level of support. However, as each individual contact point is small, the task of disconnecting each beam 16 from the part 14 is relatively simple and the risk of such separation causing damage to the surface of the part 14 is reduced. Furthermore, the strength of the bond between each beam 16 and the part 14 may be controlled depending upon the support requirement. By way of example, where the loads to be experienced by a beam 16 are compressive loads, it may be sufficient for the beam 16 or some of the beams 16 to stop short of the part 14, for example stopping approximately 0.25 mm short of the part 14 so that only a very weak bond is formed between the part 14 and the beam 16. Whilst stopping short of the part 14, it will be appreciated that during the manufacturing process heat transfer will still occur and the beam 16 will still be weakly bonded thereto and so the beam 16 substantially interconnects the part 14 and the table 18. The relatively weak bond formed in this manner may allow the amount of finishing work required once the support has been separated from the product to be reduced. If desired, the relatively weak bond achieved in this manner may extend over a relatively large area. On the other hand, where relatively large loadings need to be transmitted between the part 14 and the beam 16, the beam 16 may extend continuously to the part 14 so as to form a stronger bond therewith.

As shown in FIG. 1, the irregular lattice of beams 16 is of substantially random form. The random nature of the lattice is thought to be advantageous in that the risk of fractures propagating through the lattice is reduced compared to an arrangement in which the lattice is of regular form. The lattice is thus of enhanced strength.

It will be appreciated that compared to the use of a typical support, the lattice support structure of the invention is advantageous in that it may allow improved removal of untreated material, and that the support can be tailored to the requirements of the product, ensuring that the various parts of the product are properly supported during the manufacturing process whilst avoiding the use of excessive quantities of material. By the use of a large number of interconnected beams forming an irregular lattice, the support provided to the product is localised and so can be varied to meet the requirements of the product. It may also be directional. Whilst the term ‘support’ is used herein, it will be appreciated that the support may in fact serve as a tie or retainer, restraining part of the product against movement. The support design may also be tailored to ensure that the cooling requirements of the product are properly met. In designing the support, account can be taken of stresses which are generated within the support during the manufacturing process as well as the stresses generated within the product. The irregular lattice nature of the support, made up of a plurality of interconnected beams, allows the lattice to be self supporting during the manufacturing process. Depending upon the design, the build time for a lattice support may be shorter than is required for a conventional support.

The shape and density of the beams 16 may be chosen such that the irregular lattice formed by the interconnected beams 16 takes on a cellular or foam-like form. In order to avoid the trapping of powder within the cells of the lattice, where the lattice is of this form, the lattice is conveniently designed in such a manner that it takes on an open-cell foam-like form.

FIG. 2 illustrates an arrangement in which the product 10 is of generally U-shaped, tubular form, the support 12 including an external part 12a, and a part 12b formed internally of the product 10 to as to provide support for the upper part 14b thereof during manufacture, both parts 12a, 12b taking the form of irregular lattices. Whilst FIG. 2 illustrates a generally U-shaped product, it will be appreciated that the invention is applicable to products of other shapes. The provision of a support designed in such a manner that each beam 16 is only weakly bonded to the product 10 as mentioned above is thought to be particularly advantageous in such an arrangement as removal of the support part 12b from within such a product and subsequent finishing of such a product, especially if the product is of complex shape, is difficult. By using a support which is only bonded relatively weakly to the product, it may be possible to use a blasting process to release the support from within the product, and the weak nature of the bonds between the support and the product not only permit the use of such a technique in the removal of the support but also results in the need for only limited subsequent finishing of the product. Alternatively, by appropriate design of the support part 12b, it may be possible to arrange for a load applied to the support part 12b to sequentially break the bonds between the support part 12b and the product 10 for subsequent removal from the product 10. As access to the interior of a product of tubular shape is difficult, especially where the product is of U-shaped or other more complex convoluted form, minimising the amount of finishing of the interior thereof is especially beneficial.

If desired, the internal support part 12b could be designed to include relatively rigid regions and relatively weak regions, the weaker regions being arranged to be removed by the use of, for example, a blast technique, creating space to allow the relatively rigid regions to move to detach from the product and to be removed from the product. Alternatively, the support part 12b could comprise a relatively weak sleeve, weakly bonded to the internal surface of the product, and a relatively strong core providing support to the relatively weak sleeve. In such an arrangement, a blast technique may be used to release and remove the relatively weak sleeve, freeing the core from the product for subsequent removal.

As the support 12 is built up and connections between the support 12 and the product 10 are completed, it will be appreciated that the level of support provided to the product 10 will vary. By appropriate design of the support 12, this effect may be amplified or controlled as desired. By way of example, there may be points in the build process during which it is desirable for the support to allow a degree of flexing of the product, or parts thereof, and at other points in the build process it may be preferred for the support to rigidly support the product against movement. By appropriate design of the support, it may be possible for relatively compliant or resilient beams 16, the resilience or compliance of which is achieved by appropriate shaping thereof, to be connected to and support the product 10 during periods when some compliance is desired, the subsequent connection of more rigid beams 16 to the product 10 being used to provide a less compliant, stiffer support for the product 10 when this is required.

If desired, in any of the arrangements outlined hereinbefore, mechanisms may be provided to assist in separation of the support 12 from the product 10. By way of example, as shown in FIG. 4a, the support 12 may include an integral lever 20, handle or actuator designed in conjunction with the remainder of the support 12 such that the application of a load to the lever 12 by appropriate manipulation thereof applies loads to parts of the support 12 sufficient to break the bonds between at least some of the beams 16 and the product 10 to allow or simplify separation of the support 12 from the product 10. Alternatively, as shown in FIG. 4b, the support 12 may include an integral body 22 including a formation shaped for engagement by a suitable tool to allow the application of a load to the support 12 to assist in release of the support 12 from the product 10. By way of example, the formation could comprise a slot shaped to receive the blade of a screwdriver or the like.

Whilst the invention is described hereinbefore primarily in relation to a powder bed type additive manufacturing process, it will be appreciated that the invention is not restricted in this regard and may be applied to other forms of additive manufacturing process.

A wide range of modifications and alterations may be made to the arrangements and methods outlined hereinbefore without departing from the scope of the invention as defined by the appended claims.

1. An additive manufacturing method comprising the steps of:
using an additive manufacturing technique to manufacture a product, at least part of which is supported by a support formed integrally with the product as part of the additive manufacturing technique, wherein the support comprises a plurality of support beams when finished, extend continuously to substantially interconnect the said at least part with a support table, the beams intersecting one another to form a lattice; and
separating the support from the product;
wherein the lattice is of irregular form.

2. A method according to claim 1, wherein the lattice is of random or pseudorandom nature.

3. A method according to claim 1, wherein the interconnections of the beams are such that the lattice has a cellular or foam-like structure.

4. A method according to claim 3, wherein the lattice is of open cell foam-like form.

5. A method according to claim 1, wherein an average beam length between interconnections is less than 5 mm.

7. A method according to claim 1, wherein the a lattice density of the lattice is non-uniform and is varied such that the level of support provided to the product is tailored to the requirements of the product.

8. A method according to claim 7, wherein the density of the lattice is varied by varying at least one of the thickness of the beams and the spacing of the beams.

9. A method according to claim 7, wherein (i) the beams are all of the same thickness, (ii) some of the beams are of a different thickness to others of the beams, (iii) at least one beam is of uniform thickness through its entire length, or (iv) at least one beam is of varying thickness along its length.

10. (canceled)

11. (canceled)

12. (canceled)

13. A method according to claim 1, wherein the beams are of small dimensions, forming a small contact area between each beam and the product.

14. A method according to claim 13, wherein the contact area between each beam and the product is less than 1 mm².

15. (canceled)

16. The method according to claim 13, wherein the contact between the beams and the product is of non-uniform area.

17. A method according to claim 1, wherein the support comprises a relatively weak region and a relatively strong region, removal of the relatively weak region assisting in subsequent removal of the relatively strong region.

18. A method according to claim 1, wherein the design of at least part of the support is adaptive, varying the level of support provided as the build process proceeds.

19. A method according to claim 1, wherein the design of the support is such that at least part of the support provides at least one of a load bearing function, a retaining function and a stress accommodating funs ion whereby the support is capable of accommodating stresses within the product.

20. (canceled)

21. (canceled)

22. A method according to claim 1, wherein the support includes a mechanism whereby a load may be applied thereto for use in separation of the support from the product.

23. A method according to claim 22, wherein the mechanism comprises one of (i) a lever or the like and (ii) a body formed with a formation shaped for engagement by a tool.

24. (canceled)

25. A method according to claim 1, wherein at least one of the beams stops short of the product, extending sufficiently closely to the product as to be weakly bonded thereto.

26. An additive manufacturing method comprising the steps of:
using an additive manufacturing technique to manufacture a product, at least part of Which is supported by a support formed integrally with the product as part of the additive manufacturing technique, wherein the support comprises a plurality of support beams; and
separating the support from the product;
wherein the contact area between each individual beam and the product is less than 1 mm².

27. A method according to claim 1, wherein the additive manufacturing technique is a powder bed technique.

28. An additive manufacturing method comprising the steps of:
using an additive manufacturing technique to manufacture a product, at least part of which is supported by a support formed integrally with the product as part of the additive manufacturing technique, wherein the support comprises a plurality of support beams; and
separating the support from the product;
wherein at least one of the support beams stops short of the product, extending sufficiently closely to the product as to be weakly bonded thereto.

29. (canceled)
